(19) United States
(12) Patent Application Publication
(10) Pub. No.: US 2003/0001916 A1
(43) Pub. Date: Jan. 2, 2003

(54) Adaptive multi-image integrated system for lenticular applications

(76) Inventors: Jean Zhao, Fremont, CA (US); Jimmy Gu, Milpitas, CA (US)

Correspondence Address: ROGER PITKIN, 45275 NORTHPORT CT., FREMONT, CA, 94538, US

(21) Appl. No.: 09/885,417

(22) Filed: Jun. 21, 2001

(51) Int. Cl. B41J 29/393

(52) U.S. Cl. 347/19

(57) ABSTRACT

The present invention provides a method to make a lenticular image with a color printer (for example an inkjet printer), which simplifies the traditional, industrial, high-volume procedure and makes the lenticular application very simple and something most people can do in their home or office.

### THE FIELD OF INVENTION

The present invention deals with the field of image processing as applied to color printer technology.

### BACKGROUND OF THE INVENTION

Lenticular technology has been in existence for more than 50 years. Many systems and products have been developed to fabricate printed lenticular pieces. However, existing methods are industrial fabrication systems that are complex and high cost, limiting their use. Simplifying the process and lowering the cost will increase lenticular use and broaden its applications. The present invention requires only a normal color printer (i.e. inkjet printer) and a PC computer to print a lenticular image. Software integrated in this invention will allow users to make all lenticular effects such as 3D, motion, animation, zoom etc, in a simple, easy-to-use process.

### BRIEF SUMMARY OF THE INVENTION

This invention comprises the following parts:

1. The method that makes one digital lenticular image from several original images (3D image sequences, animation image sequence etc.), printed directly by color printers, that can print various LPI (lines per inch) lenticular lens media with a color printer at different resolutions and in different directions (horizontal or vertical).

2. The method that detects the printer properties, printer and lenticular registration and compensates for them.

Current lenticular image technology requires very high resolution, special screening and offset print technology, making it high cost and complex technology. Now that color printers, especially the inkjet printers, have developed resolution that can achieve 720 dpi to 2880 dpi and use random screening for printing a photo image, they are now ideal for creating lenticular images. In principle, for different LPI lenticular lenses, it is necessary to print with the proper resolution to avoid error, that is, the printer resolution must be a multiple of the LPI of the lenticular lens, or increased errors will occur. This was not possible until now because the printer resolution is fixed and the LPI is variable. Even when the lens and printer are closely matched, errors cannot be avoided.

In order to resolve this significant error problem, a rounding algorithm can usually be used that will limit the maximum error to half of the interval between printed lines. If the printer resolution is much greater than the LPI of the lenticular lens, this error will be greatly reduced. When a lower LPI lenticular is used such as 20 or 40 LPI, the error is less with this algorithm, but in most cases greater than 72 LPI lenticulars should be used for obtaining better visual effects. FIG. 1 shows an image integrated from a black and white image for 80 lenticular printed by a 720 dpi printer, with a normal variation shown clearly.

Because the printer resolution cannot be changed and the printer speed cannot be adjusted, it is impossible to match the lenticular lens width and line interval of the printer to get a perfect result. But even if it cannot be resolved physically, it is possible to resolve this problem visually. This invention provides an adaptive nonlinear adjacent estimation algorithm to compensate for the visual effect of error. In this method, when a separation point between adjacent input image lines is located between two print lines, adjusting the adjacent line color level adaptively creates an almost perfect visual effect. FIG. 2 shows the result of using this method for the example in FIG. 1, in which the error effect has almost disappeared.

In order to obtain some parameters for the adaptive nonlinear adjacent estimation algorithm, we provide a special image and print it. The parameters resulting from this process are shown in FIGS. 3-1 and FIGS. 3-2.

Although the precision of the printer and the lenticular lenses is very high, even 0.001 mm error in an interval between two printer lines is enough to make an unacceptable result. This small error must be found and corrected. By providing a special lenticular image, the error can be found and corrected in the software, see FIG. 4.

Because the above methods can adapt to different lenticular resolutions and printers with different precision, images can be printed either with the lenticular grain or against it (horizontally or vertically) using the same adjustment algorithm to obtain optimal results in either case. When a printer's horizontal resolution is different from its vertical resolution, the lenticular lens should be positioned with its grain at 90 degrees to the direction of the highest printer resolution. The same principle should be applied to image plotters in traditional offset printing.

Using this method, a software system integrates a multi-image sequence (for example, 3D stereo sequence, motion, rotation, zoom or other movement) to a lenticular image for printing. The user can input an image sequence, change its order, and define output image properties (size, printer type, lenticular type, etc.). Before completing the process, the user can verify the result with a simulation preview.

### BRIEF DESCRIPTION OF THE DRAWINGS

FIG. 1 shows an 80 LPI black and white lenticular image, with image resolution of 720 dpi, and printer resolution of 720×2880 dpi. This image is made with a simple rounding algorithm.

FIG. 2 shows the same image as FIG. 1, but it is made with the adaptive nonlinear adjacent estimation algorithm.

FIGS. 3-1 defines the gamma value when R=1.0 in the adaptive nonlinear adjacent estimation algorithm. The bands from left to right show their gamma from 1.55 to 2.6. In this case, the 15th band is the best, and gamma can be set to 2.25.

FIGS. 3-2 defines the R value in the adaptive nonlinear adjacent estimation algorithm (see formula 1-1 and 1-2). From top to bottom, the different levels of the two input images in the band are 100%, 80%, 60%, 40% and 20%. From left to right, R value is from 0.9 to 3.0. Gamma is 2.25 in FIGS. 3-1. In this figure, from the left, the third band on the first row, 7^{th} band on the second row, 8^{th} band on the third row, 19^{th} band on the 4^{th} row, and the 22nd band on the 5^{th} row are the best choices for each row. The corresponding R values are 1.1, 1.5, 1.6, 2.8 and 3.0.

For FIGS. 3-1 and 3-2, the image resolution is 720 dpi, and the printer resolution is 720×2880 dpi.

FIG. 4 is a precision calibration image where the band from left to right is created by the error of the lenticular lens width from −0.002 to 0.002 mm. When this image is placed under a lenticular lens sheet and inspected from different viewpoints along the band direction, at a certain position only one band shows as all black or white. The error corresponding to this band is the error of the lenticular lens. With this error value, the software can correct the lenticular width coefficient to obtain the best printing resolution.

### DETAILED DESCRIPTION OF THE INVENTION

1. Adaptive Nonlinear Adjacent Estimation Algorithm

A lenticular image must be composed by interleaving the N input images with each other, and every interval of a lenticular lens must present the N line from the N input images. To obtain the best printer effect, the resolution of the printer has to be a multiple of the lenticular image so it is not possible to just place the input image line next to the lenticular image. The input image line's separation point must be between two adjacent lenticular image lines, simply using adjacent lines to present it, or an error effect will be seen. This invention proposes an adaptive nonlinear, adjacent estimation algorithm to adjust the density of the adjacent line, relating to the separate point between the lenticular image lines, until the error effect is eliminated. This algorithm is presented as follows:

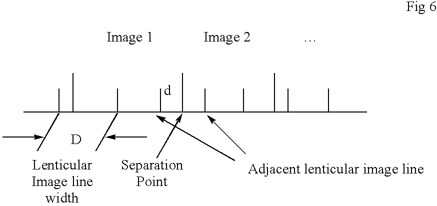

Every input image position can be calculated, according to the lenticular LPI, lenticular image resolution, and the number of input images. FIG. 6 shows an example, in which the separation point between Image 1 and Image 2 is in an interval of adjacent lenticular image lines. The lenticular image line width is D, and the distance between the separation point and the adjacent line is d. The density of this adjacent line shall be between the density of Image 1 and Image 2. The following formula presents an adaptive estimation of the density of this adjacent line:

If Clm1 is greater than Clm2

C=((C_{Im1})^{r}*(d/D)^{R}+(C_{Im2})^{r}*(1−(d/D)^{R}))^{1/r} 1-1

Else:

C=((C_{Im1})^{r}*(1−(1−d/D)^{R})+(C_{Im2})^{r}*(1−d/D)^{R})^{1/r} 1-2

In which:

R=f(|C_{Im1}−C_{Im2}|)

is an experimental function that can be defined by (2)

r=1.5−2.6

is a gamma parameter that can be defined by (2)

C_{Im1} and C_{Im2} is the density for Image 1 and Image 2.

C is the estimation density for the adjacent line in lenticular image.

Here the density is from 0 to 1, which corresponds to 0 to 255 levels in the image.

2. Define the Parameters r and R in (1-1)

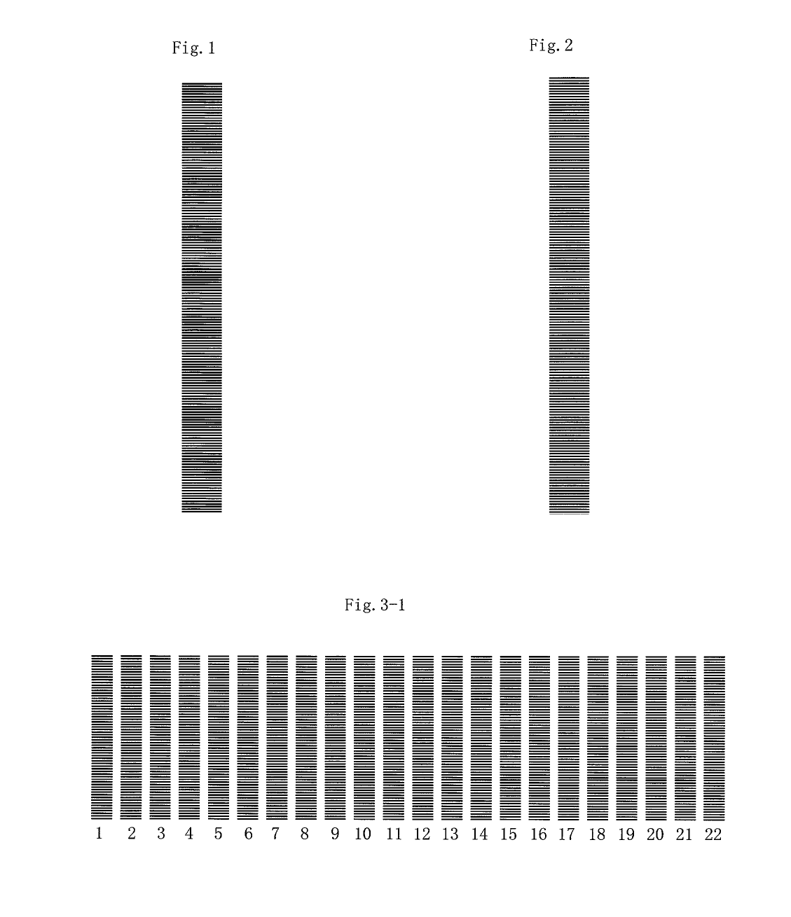

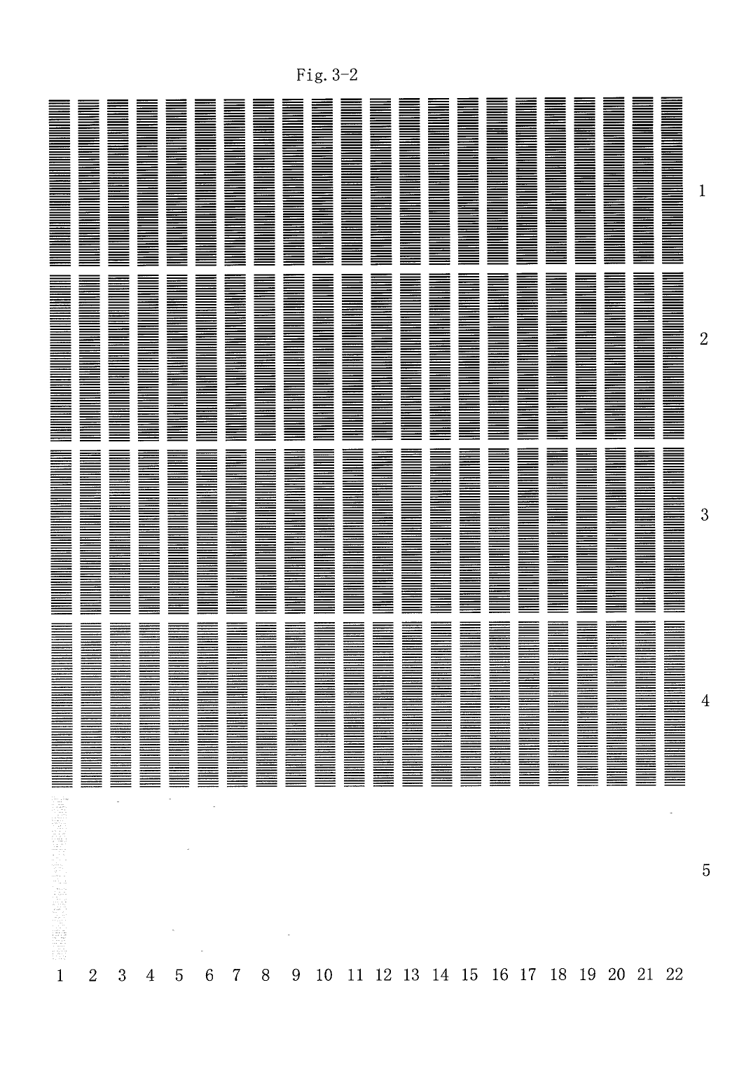

Taking R=1.0, r=1.55 to 2.6 and step 0.05, using formula 1, a white-black lenticular image is printed as in FIGS. 3-1. Every band uses a different r value. After inspecting the image carefully, choose the band which presents the most uniform color image. The r value corresponding to that band will be used as the gamma parameter.

Taking the gamma value selected and changing R from 0.9 to 3.0 for different density steps 1.0, 0.8, 0.6, 0.4, and 0.2, a lenticular image is printed as in FIGS. 3-2. In this image, the bands in the same row have the same density and present different R values. Like the previous step, in every row, choose a band that presents the most uniform color image. The R values of these bands are the best R values, corresponding to the density step of each other. From these values, using the interpolation, the R value for every density step can be defined:

R=f(s)

s=0˜255.

To simplify this process, we can take an approximate gamma, for example 1.5, and repeat the second step with good results.

3. Precision Setup

Because all calculations to integrate a lenticular image depend on the lenticular image's resolution (limited by print resolution) and lenticular LPI or lenticular lens width, the precision of these values is very important for getting a good effect. The printer specification and lenticular lens specification may be very high accuracy but there are always small errors caused by mechanical and electronic control parameters and even temperature effects, so the manufacturer's stated specifications are usually not good enough to obtain a high quality result without correcting the small errors.

It is evident that the error effects for image resolution and lenticular lens width are related. It is enough to adjust one of these parameters to correct the error. In our method, the width of the lenticular lens is estimated to have a small error and a correction value must be found for it.

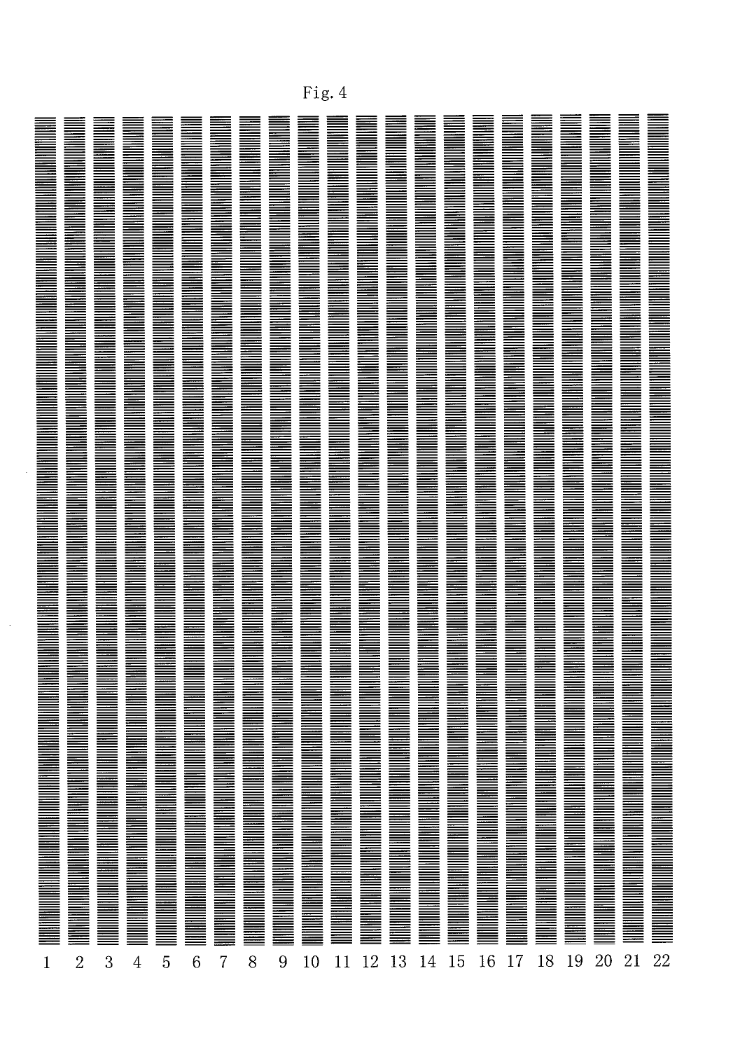

With the image resolution and lens width marked values, and a variant lens width correction value from −0.002 to 0.002 mm and step as 0.0002 mm, a test image can be made as in FIG. 4. In this image, each band corresponds to a different correction value. When this image is placed under a lenticular sheet (lenticular line is vertical to the band), and the image is inspected along the band direction, at certain view positions only one band is shown as all black or all white. The correction value corresponding to this band must be the best.

4. Application Area

The above method is based on image processing technology. It requires no modification of the printing device, and can be applied to most existing printing techniques and printing devices, including normal printers and image plotters (used for traditional offset printing). In other words, this method can be applied to almost all current printing devices.

What is claimed is:

1. Printing an integrated digital lenticular image on a lenticular lens with a color printer by applying an adaptive nonlinear adjacent estimation algorithm.

2. A method as in claim 1, adapting the image for an unmodified color printer with any resolution, and for unmodified lenticular lenses of any resolution, where the resolutions of the printer and of the lenticular lens are independent of each other.

3 A digital method for testing a printer for the calibration parameters used in claim 1

4. A digital method for creating test images for determining the small resolution errors between printer and lenticular lens, and compensating for them.

5. A method as in claims 1, 2, and 3 where printing is done by an image plotter to generate a film for standard offset printing, rather than a typical color printer.

6. A method as in claims 1, 2, and 3 where printing is done on paper or other standard medium, and then pasted to a lenticular lens to produce the final lenticular image.

7. A method as in claim 1 where error correction procedures are visual in nature and do not require any particular expertise for adjustment.

8. A method as in claim 1, 3 and 4 where visual correction can compensate for environmental differences
such as temperature and humidity as well as many manufacturing errors and defects.

9. A method as in claim 1, 3 and 4 where printer resolution, lines per inch in the lens and motor
printing speed can all be ignored in the printing process because of the compensating software.
